(19) United States
(12) Patent Application Publication
(10) Pub. No.: US 2024/0417180 A1
(43) Pub. Date: Dec. 19, 2024

(54) CONVEYER APPARATUS FOR INSPECTING AND PROCESSING PELLET-SHAPED ARTICLES

(71) Applicant: Ackley Machine Corporation, Moorestown, NJ (US)

(72) Inventor: Jonathan Adam BRY, Cherry Hill, NJ (US)

(21) Appl. No.: 18/743,502

(22) Filed: Jun. 14, 2024

Related U.S. Application Data
(60) Provisional application No. 63/508,335, filed on Jun. 15, 2023.

(51) Int. Cl. B65G 17/12; B65G 43/08; B65G 47/34

(52) U.S. Cl. CPC B65G 17/12; B65G 43/08; B65G 47/34; B65G 2201/027; B65G 2203/0216; B65G 2203/041

(57) ABSTRACT

A conveyer apparatus may inspect and process pellet-shaped articles having a first side with a first characteristic and a second side having a second characteristic. The conveyer apparatus may include: a conveyer configured to convey pellet-shaped articles, a first pre-processing camera configured to generate a first pre-processing image of each of the pellet-shaped articles, a controller configured to receive the first pre-processing image and determine whether the first side or the second side of each of the pellet-shaped articles is facing the first lateral side of the conveyer path, a first processing device and a second processing device configured to process the first side of each of the pellet-shaped articles to produce a third characteristic, a first post-processing camera and a second post-processing camera, a post-processing light source configured to illuminate pellet-shaped articles with ultraviolet light; and an ejection unit configured to eject individual ones of the pellet-shaped articles.

### CROSS-REFERENCE TO RELATED APPLICATIONS

This application claims the benefit of U.S. Provisional Application No. 63/508,335, filed Jun. 15, 2023, the entire contents of which is incorporated herein by reference.

### FIELD OF THE TECHNOLOGY

The present technology relates to methods and apparatuses for transporting, inspecting, and processing pellet-shaped articles, e.g., tablets, caplets, lentil-shaped articles, etc.

### BACKGROUND OF THE TECHNOLOGY

Inspecting and processing of pellet-shaped articles, such as marking, and/or laser drilling of pellet-shaped articles, is known in the art. Inspection units are typically configured to inspect and remove pellet-shaped articles from a conveyer mechanism that have been improperly processed in a previous processing operation. Processing operations may include marking the pellet-shaped articles with indicia, coloring the pellet-shaped articles, laser drilling holes in the pellet-shaped articles, and/or coating the pellet-shaped articles. These processing operations are typically completed upstream from the inspection unit such that the inspection unit may inspect if these processes have been properly completed.

It is important for the manufacturer to carefully inspect the pellet-shaped articles for defects, such as an improperly printed or coated side of the article, before the pellet-shaped article is distributed to the consumer so as to ensure the quality of the product and hence protect the safety of the consumer. Moreover, such defective articles must be separated from acceptable articles based on the inspection results.

The pellet-shaped articles may also have distinct and defined sides, each requiring a different processing operation to be performed. Therefore, it may be desirable to identify and process each side of the pellet-shaped article accordingly.

Furthermore, in pellet-shaped articles that have distinct and defined sides, e.g., different colors, it may be necessary to distinguish the different sides, even when the color of each respective side is only slightly different, at least visually. That is because it may be intended for only one side having a given color to be processed, e.g., by having a hole drilled.

Additionally, it may also be desirable to confirm that the hole itself was drilled to specification and on the intended side of the pellet-shaped article. It may also be desirable to confirm that a side of the pellet-shaped article that should not have been processed has actually not processed.

Known methods for identifying the side of the pellet-shaped article to be processed and then confirming that that side was processed, processed correctly, and the side not to be processed was not processed include illuminating the pellet-shaped articles with white light, imaging the pellet-shaped articles, and then analyzing the images. However, white light has drawbacks in that it may be difficult to distinguish sides of the pellet-shaped articles when the colors of the respective sides are visually similar. Also, the hole may be very small compared to the overall size of the pellet-shaped articles, and it may be difficult to accurately determine the presence or absence of a hole using white light imaging because the shadow cast by the hole that the system uses to identify it will be small. Accordingly, when there is a possibility of a hole being drilled into the dark-colored side of a pellet-shaped article, whether intended or not, the system might erroneously identify the granularity in the dark-colored side of the pellet-shaped article as a hole. In other words, there is a risk when using white light imaging that the system will indicate the presence of a hole on the dark-colored side even though there is no hole. BRIEF SUMMARY OF THE TECHNOLOGY

One aspect of the present technology is to provide a conveyer apparatus that overcomes one or more of the shortcomings of the prior art, e.g., to more accurately and efficiently process pellet-shaped articles.

Another aspect of the present technology is to provide a method for inspecting and processing pellet-shaped articles overcomes one or more of the shortcomings of the prior art, e.g., to more accurately and efficiently process pellet-shaped articles.

Another aspect of the present technology is to provide methods and apparatuses to inspect and process either or both sides of pellet-shaped articles transported on a conveyer depending on the orientation of the sides of the pellet-shaped articles.

Another aspect of the present technology is to provide methods and apparatuses to inspect and process pellet-shaped articles transported on a conveyer in a vertical or on-edge orientation.

Another aspect of the present technology is directed to a conveyer apparatus for inspecting and processing pellet-shaped articles. The conveyer apparatus comprises: a conveyer configured to convey a plurality of pellet-shaped articles; a controller configured to determine whether a first side or a second side of each of the pellet-shaped articles is facing a first lateral side of the conveyer path; a first processing device configured to process the first side of each of the pellet-shaped articles to produce a third characteristic in response to a first instruction from the controller; a first post-processing camera; a post-processing light source configured to illuminate the pellet-shaped articles with ultraviolet (UV) light, wherein the first post-processing camera is configured to generate a first post-processing image of each of the pellet-shaped articles illuminated with UV light, and wherein the controller is configured to detect presence or absence of the third characteristic. The apparatus may, in addition, include an ejection unit configured to eject individual ones of the pellet-shaped articles from the conveyer.

Another aspect of the present technology is directed to a conveyer apparatus for inspecting and processing pellet-shaped articles, each of the pellet-shaped articles including a first side with a first characteristic and a second side opposite the first side and having a second characteristic that is different from the first characteristic. The conveyer apparatus comprises: a conveyer including a plurality of carrier links configured to circulate along a conveyer path to convey a plurality of pellet-shaped articles along a portion of the conveyer path, each carrier link having a pocket configured to receive a pellet-shaped article in an orientation with the first side or the second side of the pellet-shaped article facing a first lateral side of the conveyer path and the other of the first side or the second side of the pellet-shaped article facing a second lateral side of the conveyer path; a first pre-processing camera located on the first lateral side of the conveyer path, the first pre-processing camera being configured to generate a first pre-processing image of whichever of the first side or the second side of each of the pellet-shaped articles is facing the first lateral side of the conveyer path as the pellet-shaped articles are conveyed past the first pre-processing camera; a controller configured to receive the first pre-processing image of each of the pellet-shaped articles from the first pre-processing camera and determine whether the first side or the second side of each of the pellet-shaped articles is facing the first lateral side of the conveyer path based on whether the first pre-processing image contains the first characteristic or the second characteristic; a first processing device located on the first lateral side of the conveyer path and a second processing device located on the second lateral side of the conveyer path, each of the first processing device and the second processing device being configured to process the first side of each of the pellet-shaped articles to produce a third characteristic on the first side of each of the pellet-shaped articles as the pellet-shaped articles are conveyed past the first processing device and the second processing device in response to a first instruction from the controller that is based on a determination by the controller that the first side of each of the pellet-shaped articles faces the first lateral side or the second lateral side of the conveyer path; a first post-processing camera located on the first lateral side of the conveyer path and a second post-processing camera located on the second lateral side of the conveyer path; a post-processing light source configured to illuminate the pellet-shaped articles with ultraviolet (UV) light as the pellet-shaped articles are conveyed past the first post-processing camera and the second post-processing camera; and an ejection unit configured to eject individual ones of the pellet-shaped articles from a corresponding one of the carrier links, wherein the first post-processing camera is configured to generate a first post-processing image of whichever of the first side or the second side of each of the pellet-shaped articles is facing the first lateral side of the conveyer path and illuminated with UV light and the second post-processing camera is configured to generate a second post-processing image of whichever of the first side or the second side of each of the pellet-shaped articles is facing the second lateral side of the conveyer path and illuminated with UV light, wherein the controller is configured to receive the first post-processing image and the second post-processing image of each of the pellet-shaped articles from the first post-processing camera and the second post-processing camera, respectively, and detect presence or absence of the third characteristic on the first side of each of the pellet-shaped articles in the first post-processing image or the second post-processing image, and wherein the ejection unit is configured to eject individual ones of the pellet-shaped articles from a corresponding one of the carrier links in response to a second instruction from the controller that is based on the controller detecting that the third characteristic is absent from the first side of an individual one of the pellet-shaped articles.

In examples of the aspects in the preceding paragraphs: (a) the first characteristic may be a first color and the second characteristic may be a second color that is different from the first color, (b) the first color may be lighter than the second color, (c) the first processing device may be a first laser configured to drill a hole into each of the pellet-shaped articles and the second processing device may be a second laser configured to drill a hole into each of the pellet-shaped articles, (d) the first laser and the second laser may be configured to drill the hole at a centroid of the first side of each of the pellet-shaped articles and coaxial to an axis perpendicular to a plane between the first side and the second side of each of the pellet-shaped articles, (e) the hole may be a blind hole, (f) the third characteristic may comprise at least one of the size, the shape, the depth, and the position of the hole drilled into the first side of each of the pellet-shaped articles, (g) the controller may be configured to compare at least one of the size, the shape, the depth, and the position of the hole to a hole specification and determine whether the hole drilled into the first side of each of the pellet-shaped articles is within the hole specification, (h) the controller may be configured to instruct the ejection unit to eject an individual one of the pellet-shaped articles if the controller determines that at least one of the size, the shape, the depth, and the position of the hole is not within the hole specification, (i) the controller may be configured to not instruct the first processing device and the second processing device to process the second side of each of the pellet-shaped articles, (j) the ejection unit may be configured to eject individual ones of the pellet-shaped articles from a corresponding one of the carrier links in response to a third instruction from the controller that is based on the controller detecting that the third characteristic is present on the second side of an individual one of the pellet-shaped articles, (k) a second pre-processing camera may be located on the second lateral side of the conveyer path, the second pre-processing camera being configured to generate a second pre-processing image of whichever of the first side or the second side of each of the pellet-shaped articles is facing the second lateral side of the conveyer as the pellet-shaped articles are conveyed past the second pre-processing camera, (l) the controller may be configured to receive the second pre-processing image of each of the pellet-shaped articles from the second pre-processing camera and determine whether the first side or the second side of each of the pellet-shaped articles is facing the first lateral side of the conveyer path based on whether the second pre-processing image contains the first characteristic or the second characteristic, (m) the controller may be configured to receive the second pre-processing image of each of the pellet-shaped articles from the second pre-processing camera, and the controller may be configured to determine from the first pre-processing image and the second pre-processing image whether at least one of the following: each of the pellet-shaped articles is within a predetermined size specification, each of the pellet-shaped articles is within a predetermined shape specification, and each of the pellet-shaped articles is within a predetermined position specification in the pocket of a corresponding one of the carrier links, (n) the controller may be configured to not instruct the first processing device and the second processing device to process said pellet-shaped article and to instruct the ejection unit to eject said pellet-shaped article, if the controller determines that an individual one of the pellet-shaped articles is not within at least one of the predetermined size specification, the predetermined shape specification, and the predetermined position specification, (o) the post-processing light source may be configured to emit light only in the UV spectrum, (p) a pre-processing light source may be configured to illuminate the pellet-shaped articles with ultraviolet (UV) light as the pellet-shaped articles are conveyed past the first pre-processing camera, (q) the pre-processing light source may be configured to emit light only in the UV spectrum, (r) a pre-processing light source may be configured to illuminate the pellet-shaped articles with white light as the pellet-shaped articles are conveyed past the first pre-processing camera, (s) the pre-processing light source may be configured to emit only white light, (t) a post-processing shield may be configured to block ambient light from the first post-processing camera and the second post-processing camera, (u) a pre-processing shield may be configured to block ambient light from the first pre-processing camera, (v) a feed hopper configured to feed the pellet-shaped articles into the carrier links, (w) the controller may be configured to analyze one or more of each pre-processing image and each post-processing image of each of the pellet-shaped articles by: assigning a number to each pixel in each pre-processing image and each post-processing image based on the color or light intensity detected by the controller, replacing pixels with a number above a threshold with a pixel of a first color, and replacing pixels with a number below the threshold with a pixel of a second color that is different from the first color, and/or (x) the first characteristic may be visually distinguishable from the second characteristic.

Another aspect of the present technology is directed to a system for analyzing images of pellet-shaped articles transported by in carrier links of a conveyer along a conveyer path having a first lateral side and a second lateral side, each of the pellet-shaped articles including a first side with a first characteristic and a second side opposite the first side and having a second characteristic that is different from the first characteristic, the system comprising: a processor configured to: receive a first pre-processing image of each of the pellet-shaped articles from a first pre-processing camera and determine whether the first side or the second side of each of the pellet-shaped articles is facing the first lateral side of the conveyer path based on whether the first pre-processing image contains the first characteristic or the second characteristic; instruct a first processing device located on the first lateral side of the conveyer path or a second processing device located on the second lateral side of the conveyer path to process the first side of each of the pellet-shaped articles to produce a third characteristic on the first side of each of the pellet-shaped articles as the pellet-shaped articles are conveyed past the first processing device and the second processing device based on a determination that the first side of each of the pellet-shaped articles faces the first lateral side or the second lateral side of the conveyer path; receive a first post-processing image and a second post-processing image of each of the pellet-shaped articles from a first post-processing camera and a second post-processing camera, respectively, and detect presence or absence of the third characteristic on the first side of each of the pellet-shaped articles in the first post-processing image or the second post-processing image; and instruct an ejection unit to eject individual ones of the pellet-shaped articles from a corresponding one of the carrier links if the processing system detects that the third characteristic is absent from the first side of an individual one of the pellet-shaped articles.

In examples of the aspect of the preceding paragraph: (a) the first post-processing image and the second post-processing image may depict each of the pellet-shaped articles illuminated with ultraviolet (UV) light from a post-processing light source, and/or (b) the processing system may be configured to analyze one or more of each pre-processing image and each post-processing image of each of the pellet-shaped articles by: assigning a number to each pixel in each pre-processing image and each post-processing image based on the color or light intensity detected by the controller, replacing pixels with a number above a threshold with a pixel of a first color, and replacing pixels with a number below the threshold with a pixel of a second color that is different from the first color.

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

The accompanying drawings facilitate an understanding of the various examples of this technology. In such drawings:

FIG. 1 is a perspective view of a conveyer apparatus including inspection, processing, and ejection units according to an example of the present technology.

FIG. 2 is a top schematic view of a conveyer apparatus including inspection, processing, and ejection units according to an example of the present technology.

FIG. 3 is a side schematic view of a conveyer apparatus including inspection, processing, and ejection units according to an example of the present technology.

FIG. 4A is a side view of a pellet-shaped article according to an example of the present technology.

FIG. 4B is a top view of a pellet-shaped article according to an example of the present technology.

FIG. 4C is a cross-sectional view of a pellet-shaped article taken through line 4C-4C of FIG. 4B.

FIG. 5 is a schematic view of a control system of a conveyer apparatus according to an example of the present technology.

FIG. 6 is a cross-sectional view of the surface of a pellet-shaped article having a hole and being irradiated according to an example of the present technology

FIG. 7 is a perspective view of a pellet-shaped article according to an example of the present technology.

FIG. 8A shows a first side of the pellet-shaped article from FIG. 7 in a carrier link, irradiated with UV light, and imaged in the visible light spectrum according to an example of the present technology.

FIG. 8B is a binarized version of the image in FIG. 8A according to an example of the present technology.

FIG. 8C is a side view of the pellet-shaped article from FIG. 8A according to an example of the present technology.

FIG. 9A shows a second side of the pellet-shaped article from FIG. 7 in a carrier link, irradiated with UV light, and imaged in the visible light spectrum according to an example of the present technology.

FIG. 9B is a binarized version of the image in FIG. 9A according to an example of the present technology.

FIG. 9C is a side view of the pellet-shaped article from FIG. 9A according to an example of the present technology.

FIG. 10 is a perspective view of a pellet-shaped article according to an example of the present technology.

FIG. 11A shows a first side of the pellet-shaped article from FIG. 10 in a carrier link, irradiated with UV light, and imaged in the visible light spectrum according to an example of the present technology.

FIG. 11B is a binarized version of the image in FIG. 11A according to an example of the present technology.

FIG. 11C is a side view of the pellet-shaped article from FIG. 11A according to an example of the present technology.

FIG. 12A shows a second side of the pellet-shaped article from FIG. 10 in a carrier link, irradiated with UV light, and imaged in the visible light spectrum according to an example of the present technology.

FIG. 12B is a binarized version of the image in FIG. 12A according to an example of the present technology.

FIG. 12C is a side view of the pellet-shaped article from FIG. 12A according to an example of the present technology.

FIG. 13 is a perspective view of a pellet-shaped article according to an example of the present technology.

FIG. 14A shows a first side of the pellet-shaped article from FIG. 13 in a carrier link, irradiated with UV light, and imaged in the visible light spectrum according to an example of the present technology.

FIG. 14B is a binarized version of the image in FIG. 14A according to an example of the present technology.

FIG. 14C is a side view of the pellet-shaped article from FIG. 14A according to an example of the present technology.

FIG. 15A shows a second side of the pellet-shaped article from FIG. 13 in a carrier link, irradiated with UV light and imaged in the visible light spectrum according to an example of the present technology.

FIG. 15B is a binarized version of the image in FIG. 15A according to an example of the present technology.

FIG. 15C is a side view of the pellet-shaped article from FIG. 15A according to an example of the present technology.

FIG. 16A is a perspective of a pellet-shaped article having a hole drilled within specification according to an example of the present technology.

FIG. 16B is a side of a pellet-shaped article having a hole not drilled within specification according to an example of the present technology.

FIG. 16C is a perspective of a pellet-shaped article having a hole not drilled within specification according to an example of the present technology.

FIG. 16D is a perspective of a pellet-shaped article having a hole not drilled within specification according to an example of the present technology.

FIG. 17 is a flowchart depicting steps for inspecting and processing pellet-shaped articles according to an example of the present technology.

### DETAILED DESCRIPTION

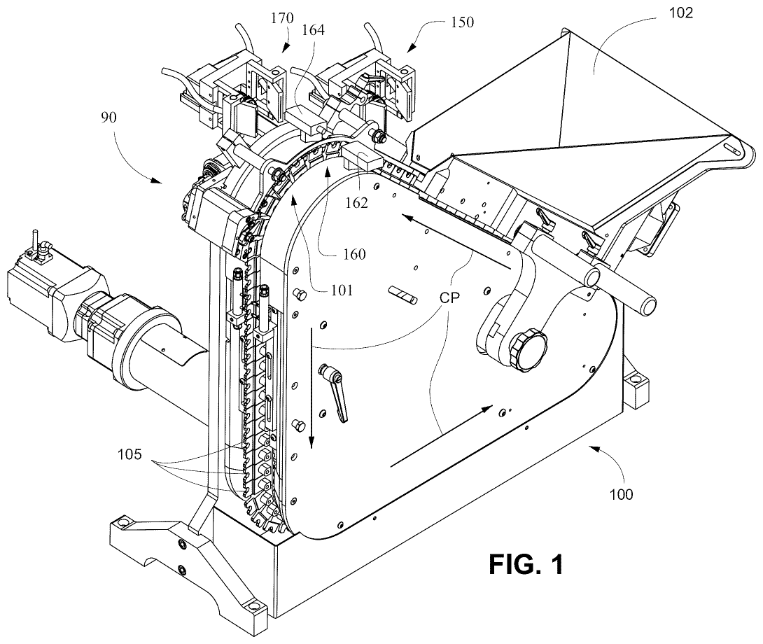

Depicted in FIG. 1 is a conveyer apparatus 100 for transporting, inspecting, and processing (e.g., marking or drilling with a laser or printing) pellet-shaped articles. In the depicted example, the conveyer apparatus 100 may include a conveyer 101 that transports the pellet-shaped articles 50 along a portion of a conveyer path CP. The conveyer apparatus 100 may also include carrier links 105 that circulate along the conveyer path CP, each carrier link 105 having a pocket 106 to transport individual pellet-shaped articles 50 along the conveyer path CP. It should be understood, however, that alternative examples of the technology may include carrier links 105 having multiple pockets such that each carrier link is able to transport multiple pellet-shaped articles.

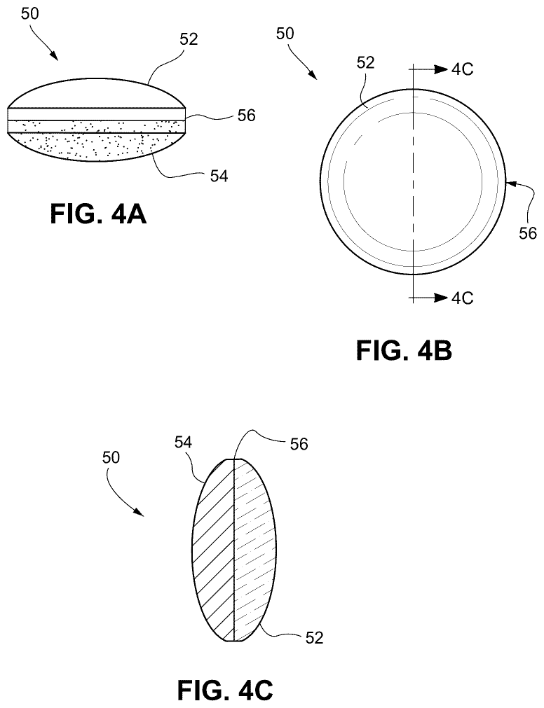

An example of a pellet-shaped article 50 is shown in FIGS. 4A, 4B, and 4C. FIG. 4A shows a side view of the pellet-shaped article 50 with a first side 52, a second side 54 opposite the first side, and a belly band 56 located between the first side 52 and the second side 54. The first side 52 and the second side 54 may have a first characteristic and a second characteristic, respectively, that are different from one another. This is indicated in FIG. 4A by stippling on the second side. The first and second characteristics may be different colors and/or textures, for example, and the first side 52 may be colored differently from the second side 54. The color of the first side 52 may be lighter than the color of the second side 54. In this example, each of the first side 52 and the second side 54 are approximately equal in volume, and each of the first side 52 and the second side 54 forms half of the belly band 56 such that the belly band 56 is half the color of the first side 52 and half the color of the second side 54. The belly band 56 may also be colored the same as one of the first side 52 and the second side 54, or the belly band 56 may be colored differently from both sides. FIG. 4B shows a top view of the pellet-shaped article 50 such that the first side is visible, as well as the belly band 56. FIG. 4C shows a cross-sectional view taken through line 4C-4C of FIG. 4B. The profile of the first side 52, the second side 54, and the belly band 56 can be seen in this view. In further examples, there may be no belly band 56. Each of the first side 52 and the second side 54 may be in the shape of a spherical cap, except that where the pellet-shaped article 50 has the belly band 56, a portion of each side may also be shaped to form the belly band 56.

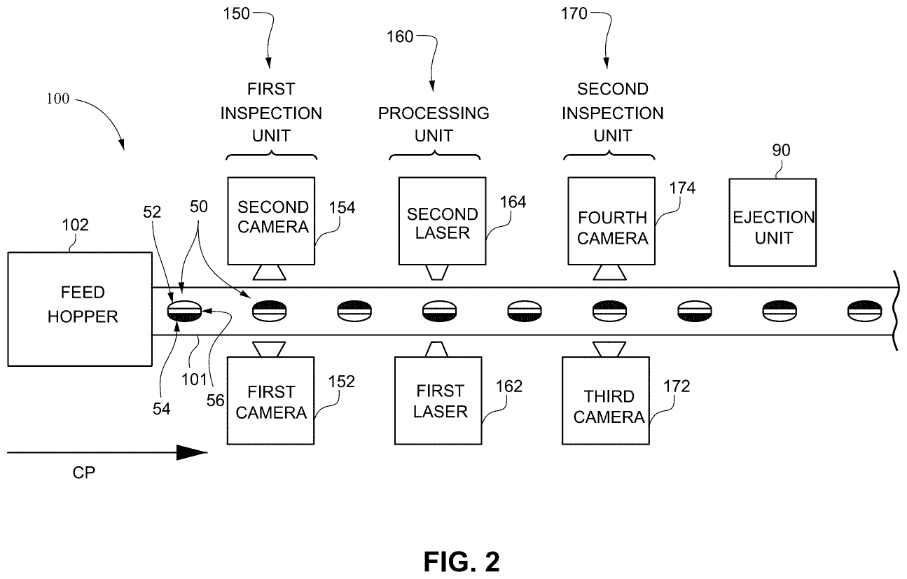

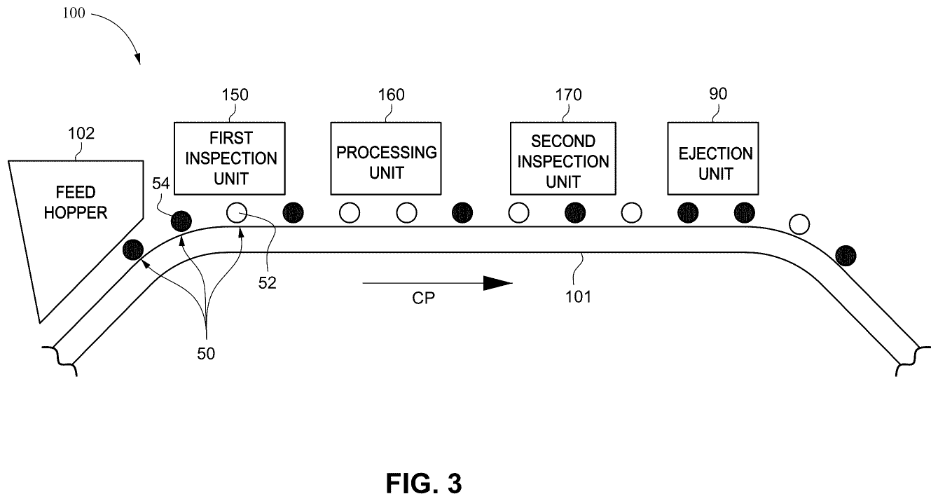

Returning to FIG. 1, the pellet-shaped articles may be fed onto the conveyer 101 by a feed hopper 102. The feed hopper 102 may be designed to hold a large number of pellet-shaped articles 50 supplied thereto in bulk. As the carrier links 105 of the conveyer 101 pass the feed hopper 102, individual ones of the pellet-shaped articles 50 may be taken into pockets 106 of the carrier links 105 for inspecting and processing by the conveyer apparatus 100. The pellet-shaped articles 50 may be fed onto the carrier links 105 in a vertical or on-edge orientation such that a plane defined through the belly band is parallel to the conveyer path CP. In other words, either the first side 52 or the second side 54 may be visible when viewed from a position transverse to the conveyer path CP, as can be seen in FIG. 3 depicting a side schematic view of the conveyer apparatus 100. FIG. 2 depicts a top schematic view of the conveyer apparatus 100. In this view, similar to FIG. 4A, the first side 52, the second side 54, and the belly band 56 are shown. This orientation may be advantageous in that the first side 52 and the second side 54 of the pellet-shaped article 50 may be inspected simultaneously and, if desired, processed simultaneously as shown in FIG. 2 and described in greater detail below.

It should also be understood that, as shown in FIGS. 2 and 3, the pellet-shaped articles 50 may be fed onto the conveyer 101 with the first side 52 and the second side 54 oriented randomly relative to the conveyer path CP. This may occur as a result of the pellet-shaped articles 50 being contained loosely in the feed hopper 102 in bulk and fed onto the conveyer 101. As will be discussed below, the randomness of the feeding of the pellet-shaped articles 50 to the conveyer 101 may necessitate that the conveyer apparatus 100 determine the orientation of the first side 52 and the second side 54 to be processed accordingly. An advantageous feature of this arrangement is that in examples of the present technology, the pellet-shaped articles 50 need not be or are not inverted or flipped as they are transported on the conveyer 101 along the conveyer path CP. In other words, the orientation of the first side 52 and the second side 54 of the pellet-shaped articles does not change as the pellet-shaped articles 50 pass along the conveyer path CP, but respective sides can be processed and inspected as needed regardless of orientation.

According to an example of the present technology, the pellet-shaped articles transported on the conveyer may pass a first inspection unit 150 as shown in FIG. 1. The first inspection unit 150 may include at least one camera for pre-processing inspection of the pellet-shaped articles 50. The features and functions of the first inspection unit 150 will be discussed in greater detail below.

After passing the first inspection unit 150, the pellet-shaped articles may then be processed by a processing unit 160 as shown in FIG. 1. The processing unit 160 may include a first laser 162 and a second laser 164 to process the pellet-shaped articles 50. The features and functions of the processing unit 160 will be discussed in greater detail below.

Once processed, the pellet-shaped articles may pass a second inspection unit 170 as shown in FIG. 1. The second inspection unit 170 may include at least one camera for post-processing inspection of the pellet-shaped articles 50. The features and functions of the second inspection unit 170 will be discussed in greater detail below.

Once the pellet-shaped articles 50 have passed the second inspection unit 170, they may pass an ejection unit 90 as shown in FIG. 1. The ejection unit 90 may be included in the conveyer apparatus 100 to eject pellet-shaped articles from the conveyer 101 that have been found by the inspection units to be defective and/or defectively processed.

After the pellet-shaped articles 50 pass the ejection unit 90, they may continue on the conveyer 101 for further inspection, processing, storage, packaging, etc.

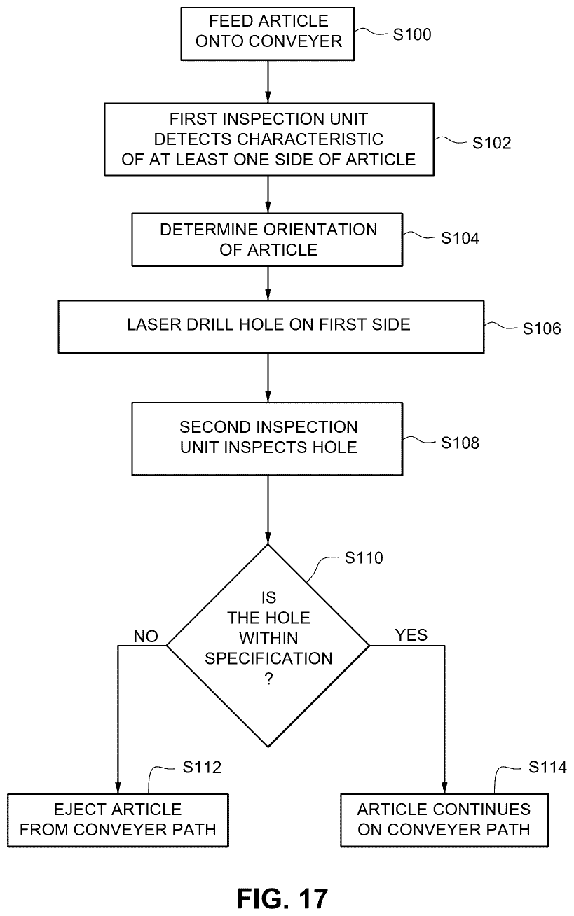

FIG. 17 shows a flowchart of a method for transporting, inspecting, and processing pellet-shaped articles 50. At S100, the pellet-shaped articles 50 are fed onto the conveyer 101 in an on-edge orientation as described above. The conveyer 101 then transports the pellet-shaped articles 50 to the first inspection unit 150.

At S102 the first inspection unit 150 may detect a characteristic of at least one side of the pellet-shaped article being inspected. As shown in FIG. 2, the first inspection unit 150 may include a first camera or a first pre-processing camera 152 and a second camera or a second pre-processing camera 154, each of which generates an image of a characteristic of the side that is visible to that camera. Thus, if the first side 52 is visible to the first pre-processing camera 152, then the first pre-processing camera 152 may detect the color or the texture that represents the first characteristic, and the second pre-processing camera 154 may detect the color or the texture that represents the second characteristic of the second side 54, or vice versa. Based on the characteristic in the image from each of the first pre-processing camera 152 and the second pre-processing camera 154, a controller 200 (described in detail below) may determine the orientation of each pellet-shaped article 50 as shown at S104. The orientation of the first side 52 and the second side 54 may be important as it may be desirable to process only one of the first side 52 and the second side 54 of each pellet-shaped article 50 or to process respective sides of each pellet-shaped article 50 differently.

Furthermore, by detecting the characteristic of each side of each pellet-shaped article 50, the conveyer apparatus 100 can more accurately determine the orientation of each pellet-shaped article 50. This may be advantageous in the situation where a pellet-shaped article 50 was produced incorrectly such that both sides have the same color or texture. The images from the first pre-processing camera 152 and the second pre-processing camera 154 may also depict other defects in the pellet-shaped articles 50, such as being damaged or misshapen. The images from the first pre-processing camera 152 and the second pre-processing camera 154 may also depict that a given pellet-shaped article 50 did not seat properly in the pocket 106 of the carrier link 105. If any of these conditions is detected, the controller 200 may determine that the pellet-shaped article 50 is defective such that it is not processed or inspected further and ejected.

Alternatively, the first inspection unit 150 may include only one camera, the first pre-processing camera 152 for example, to detect the side of the pellet-shaped article 50 visible to the camera, and then the controller 200 may use a single image of one side of the pellet-shaped article 50 to determine the orientation of the first side 52 and the second side 54. Thus, if only the first pre-processing camera 152 is included and this camera generates an image of the first characteristic, then the controller 200 may determine that the first side 52 is oriented on that side of the conveyer 101 and the second side 54 is oriented toward the opposite side, or vice versa.

The conveyer apparatus 100 may also include one or more light sources positioned proximal to the first pre-processing camera 152 (and the second pre-processing camera 154) to illuminate the pellet-shaped articles 50 for imaging at this stage. The light source(s) may emit white light or the light source(s) may emit light only in the UV spectrum. White light may be sufficient because it permits differentiation of the two differently colored sides of each pellet-shaped article, so its orientation can be determined. UV light may be an advantageous alternative for use at this stage because it produces greater contrast on the surface of the pellet-shaped articles 50 so that the defects described above can more easily be identified through analysis with the controller 200.

A shield may also be positioned around the first pre-processing camera 152 and the second pre-processing camera 154, if included, to prevent ambient light from reaching these cameras during inspection and contaminating the images.

Once the controller 200 has determined the orientation of each pellet-shaped article 50, it will be processed accordingly by the processing unit 160 as indicated by S106 of FIG. 17. The processing unit 160 may, in various examples of the technology, include at least two processing devices, each being located opposite one another relative to the conveyer 101. The processing devices may include lasers (for lasering hole(s), logo(s), alphanumeric character(s), etc.), printers, composition-scanning devices, etc. As can be seen in FIGS. 1 and 2, the processing unit 160 may include a first processing device in the form of a first laser 162 and a second processing device in the form of a second laser 164.

According to one example of the technology, the first side 52 of each pellet-shaped article 50 is to be laser-drilled with a hole 53 and the second side 54 is not processed. The controller 200 may instruct the first laser 162 and the second laser 164 accordingly based on the image from the first pre-processing camera 152 alone or based on images from the first pre-processing camera 152 and the second pre-processing camera 154. It should also be understood that the processing unit 160 may, according to another example of the technology, drill both sides of individual pellet-shaped articles substantially simultaneously or drill and print respective sides of individual pellet-shaped articles 50 substantially simultaneously. The mark may include at least one of a symbol, an alphanumeric character, and artwork. The hole 53 may be cylindrical or conical in shape. The hole 53 may be a blind hole or it may be a through-hole. The hole may be laser-drilled at a centroid of the first side 52 of each of the pellet-shaped articles 50 and coaxial to an axis perpendicular to a plane between the first side 52 and the second side 54 of each of the pellet-shaped articles 50. The hole 53 and the mark each may include a third characteristic and a fourth characteristic, respectively, defining some feature thereof. The third and fourth characteristics may include one or more of a dimension or size of the hole 53 or the mark, the shape of the hole 53 or the mark, the depth of the hole 53 or mark, and the position of the hole 53 or mark on the pellet-shaped article.

Since the pellet-shaped articles 50 may be positioned on the conveyer 101 in either orientation, the first laser 162 and the second laser 164 may each be programmed to laser-drill the hole 53. Thus, depending on the orientation of the pellet-shaped articles 50 on the conveyer, the first laser 162 may laser-drill the hole 53 on the first side 52 of one of the pellet-shaped articles because the first side is oriented towards the first laser 162. Then, the subsequent pellet-shaped article 50 may have its second side 54 facing the first laser 162 such that the second laser 164 will laser-drill the hole 53 on the first side 52 of that pellet-shaped article 50. Therefore, it should be understood that either laser is capable of drilling either side of each pellet-shaped article according to the orientation detected and determined by the first inspection unit 150.

Alternatively, the processing unit 160 may include dedicated processing devices on either side. For example, the processing unit 160 may include four lasers with two located on either side of the conveyer path CP. Each of the pair of lasers on either side of the conveyer path CP may be programmed such that one is dedicated to laser-print the mark and the other is dedicated to laser-drill the hole. Thus, the pellet-shaped articles 50 can be properly processed regardless of orientation and without the need for lasers that perform multiple processing functions.

Once processed by the processing unit 160, the pellet-shaped articles pass to the second inspection unit 170 as shown at S108 in FIG. 17. The second inspection unit 170 may then inspect the hole 53 of each pellet-shaped article 50. The second inspection unit 170 may include a third camera or a first post-processing camera 172 and a fourth camera or a second post-processing camera 174 to identify which side of each pellet-shaped article 50 it is facing and inspect the processing operation performed thereon. As described above, the first inspection unit 150 may, in an alternative example, include only one camera, i.e. the first camera, to determine the orientation of pellet-shaped articles, however in such an example of the technology the second inspection unit 170 would include two cameras, i.e., the first post-processing camera 172 and the second post-processing camera 174, so that either or both sides of the pellet-shaped articles 50 may be inspected after processing.

The conveyer apparatus 100 may also include one or more light sources positioned proximal to the first post-processing camera 172 and the second post-processing camera 174 to illuminate the pellet-shaped articles 50 for imaging at this stage. The light source(s) may emit white light or the light source(s) may emit light only in the UV spectrum. UV light may be advantageous at this stage because it produces greater contrast on the surface of the pellet-shaped articles 50 so that the defects described above can more easily be identified through analysis with the controller 200.

A shield may also be positioned around the first post-processing camera 172 and the second post-processing camera 174 to prevent ambient light from reaching these cameras during inspection and contaminating the images.

According to one example, when a pellet-shaped article passes through the second inspection unit 170 each camera identifies the side of the pellet-shaped article based on whether the first characteristic or the second characteristic is detected. Then, for example, if the first characteristic is detected by the first post-processing camera 172, then the second inspection unit 170 determines that the first side 52 is facing the first post-processing camera 172. Accordingly, the controller 200 can compare the third characteristic in the image of the first side 52 of the pellet-shaped article 50 to a hole specification as shown at S110 of FIG. 17. Concurrently, the second post-processing camera 174 may be inspecting the opposite side of the pellet-shaped article 50. If the second post-processing camera 174 detects the second characteristic, then the second inspection unit 170 determines that the second side 54 is facing the second post-processing camera 174. Accordingly, if desired, the controller 200 can compare the fourth characteristic of the second side 54 of the pellet-shaped article to a mark specification as shown at S110 of FIG. 17.

If the first post-processing camera 172 detects that the third characteristic of the hole 53 is within the hole specification and, if desired, the second post-processing camera 174 detects that the fourth characteristic of the mark is within the mark specification, then the pellet-shaped article may continue on the conveyer 101 according to S114 of FIG. 17. If one or both of the hole and, if desired, the mark are not within their respective specification, then the controller 200 may determine that that pellet-shaped article 50 is defective and instruct the ejection unit 90 to eject that pellet-shaped article 50 from the conveyer 101 as in S112 of FIG. 17. Also, if the controller 200 identifies a hole 53 in the second side 54 of a pellet-shaped article 50 based on images from the first post-processing camera 172 and the second post-processing camera 174 (i.e., where a hole should not be in that example), then the controller 200 may determine that the pellet-shaped article 50 is defective and instruct the ejection unit 90 to eject it.

The ejection of defective pellet-shaped articles may be performed by single ejecting each defective pellet-shaped article with the ejection unit 90. Ejecting only the pellet-shaped articles 50 determined to be defective is advantageous in that waste is avoided. Single ejection may be accomplished by an ejection system described in U.S. Pat. No. 8,381,896, which is incorporated herein by reference in its entirety. According to another example of the technology, an additional ejection unit may be included along the conveyer path CP of the conveyer apparatus 100 immediately following the first inspection unit 150 so as to allow for the ejection of pellet-shaped articles 50 found defective by the controller 200 after imaging by the first pre-processing camera 152 or the second pre-processing camera 154.

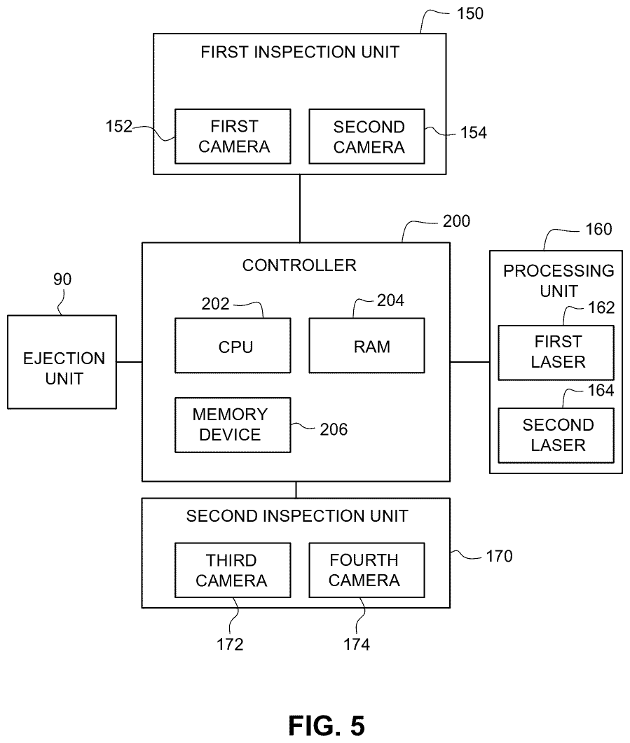

FIG. 5 shows a control system of a conveyer apparatus according to an example of the present technology. In addition to the first inspection unit 150, the processing unit 160, the second inspection unit 170, and the ejection unit 90, the conveyer apparatus 100 may also include the controller 200. The controller 200 may include a processor, e.g., in the form of a central processing unit or CPU 202, RAM 204 and a memory device 206. The memory device 206 can be magnetic, flash based, solid state, or other storage technology.

Furthermore, in FIG. 5 the controller 200 may be a computing device (which may also be referred to, for example, as a “computing device,” “computer system,” or “computing system”). The controller 200 may include one or more of the following: one or more processors, e.g., the CPU 202, (which may be referred to as “hardware processors” or individually as a “hardware processor”); one or more memory devices, 206, as well as the RAM 204. The controller 200 may also include one or more network interface devices; one or more display interfaces; and one or more user input adapters. Additionally, in some examples, the controller 200 may be connected to or include a display device. As will explained below, these elements (e.g., processor(s) 202, RAM 204, memory device(s) 206, network interface devices, display interfaces, user input adapters, display device) are hardware devices (for example, electronic circuits or combinations of circuits) that are configured to perform various different functions for the controller 200. In some examples, these components of the controller 200 may be collectively referred to as computing resources (e.g., resources that are used to carry out execution of instructions and include the processors (one or more processors 202), storage (one or more RAM 204 and/or memory devices 206), and I/O (network interface devices, one or more display interfaces, and one or more user input adapters). In some instances, the term processing resources may be used interchangeably with the term computing resources.

In some examples, multiple instances of the controller 200 may be arranged into a distributed computing system, as described. For example, the controller 200 may also be a distributed system that includes one or multiple processors. In an example using multiple processors, one of the processors may analyze pre-processing images and another one of the processors may analyze the post-processing images.

In some examples, each or any of the processors is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, a graphics processing unit (GPU), or a system-on-a-chip (SOC) (e.g., an integrated circuit that includes a CPU and other hardware components such as memory, networking interfaces, and the like). And/or, in some examples, each or any of the processors 202 uses an instruction set architecture such as x86 or Advanced RISC Machine (ARM).

In some examples, each or any of the memory devices 206 is or includes a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 202). Memory devices 206 are examples of non-transitory computer-readable storage media. The RAM 204 may be a random access memory (RAM) (such as a Dynamic RAM (DRAM) or Static RAM (SRAM)).

In some examples, each or any of the network interface devices includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), LTE Pro, Fifth Generation New Radio (5G NR) and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some examples, the transmitter and receiver of a transceiver may not share any common circuitry and/or may be in the same or separate housings.

In some examples, data is communicated over an electronic data network. An electronic data network includes implementations where data is communicated from one computer process space to computer process space and thus may include, for example, inter-process communication, pipes, sockets, and communication that occurs via direct cable, cross-connect cables, fiber channel, wired and wireless networks, and the like. In certain examples, network interface devices may include ports or other connections that enable such connections to be made and communicate data electronically among the various components of a distributed computing system.

Alternatively, or additionally, in some examples, the controller 200 includes one or more of: a processing system that includes the processor(s) 202; a memory or storage system that includes the memory devices 206 and the RAM 204; and a network interface system that includes the network interface devices. Alternatively, or additionally, in some examples, the controller 200 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processor(s) 202 and the network interface devices; or the single SoC (or the multiple SoCs) may include the processor(s) 202, the network interface devices, and the memory devices 206 and/or the RAM 204; and so on. The controller 200 may be arranged in some examples such that: the processor(s) 202 include a multi or single-core processor; the network interface devices include a first network interface device (which implements, for example, WiFi, Bluetooth, NFC, etc.) and a second network interface device that implements one or more cellular communication technologies (e.g., 3G, 4G LTE, CDMA, etc.); the memory devices 206 and the RAM 204. As another example, the controller 200 may be arranged such that: the processor(s) 202 include two, three, four, five, or more multi-core processors; the network interface devices include a first network interface device that implements Ethernet and a second network interface device that implements WiFi and/or Bluetooth; and the memory devices 206 include the RAM 204 and a flash memory or hard disk.

The controller 200 may be included to perform functions such as the determination of the orientation of the pellet-shaped articles on the conveyer S104 and the determination of whether the hole and, if desired, the mark are within their respective specification S110. Thus, the first inspection unit 150 and the second inspection unit 170 may communicate images of the pellet-shaped articles 50 to the controller 200, which in turn performs the determination functions discussed above. Once the orientation of an individual pellet-shaped article is determined, the controller 200 may also instruct the processing unit 160 as to which processing function(s) are to be performed. Also, the second inspection unit 170 may communicate images of the pellet-shaped articles 50 to the controller 200 to determine whether the processing functions were performed properly. Based on the orientation of the pellet-shaped articles determined previously, the controller 200 may then compare the hole and the mark, for example, to the hole and mark specifications. Then, based on that comparison, the controller 200 may instruct the ejection unit 90 to eject individual pellet-shaped articles 50 if they are determined to be defectively processed.

Alternatively, the conveyer apparatus 100 may utilize “smart” cameras in the inspection units 150, 170 to perform the determination functions. Rather, than a controller 200 that is in communication with the functional elements as discussed above, so called “smart” cameras may individually include controllers to perform these functions within the cameras themselves. In such a case, the first inspection unit 150 and the second inspection unit 170 may be in communication with the processing unit 160 and the ejection unit 90 to provide these elements with instructions based on the determinations performed at the inspection units.

In further examples, the analysis of pre-processing images at S104 and/or of post-processing images at S110 may be performed remotely from the conveyer apparatus 100, such as in the cloud, at an external data center, or by a control system that is located near the conveyer apparatus 100, e.g., within the same building, but physically separate from the conveyer apparatus 100.

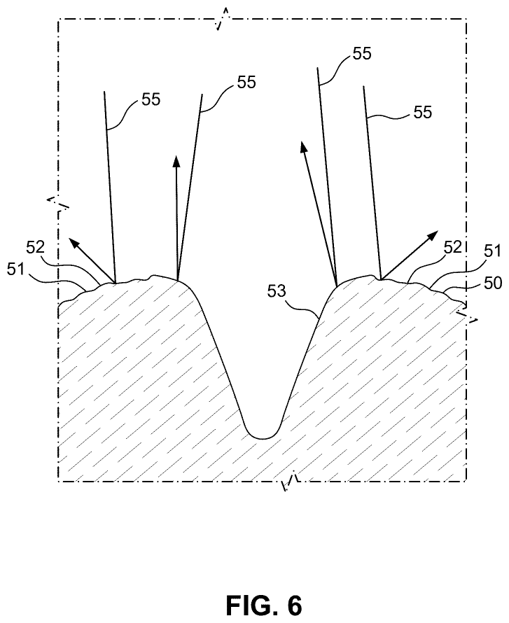

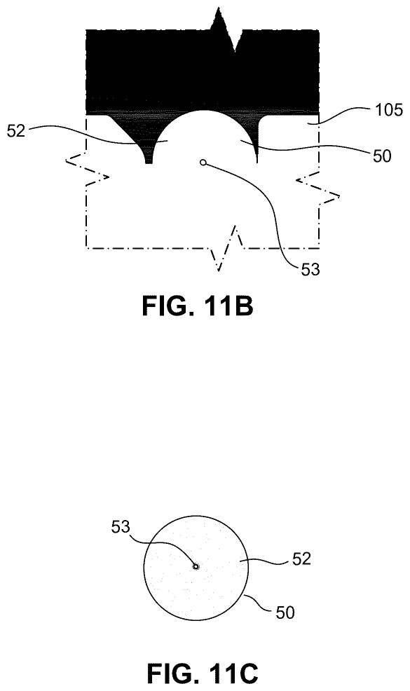

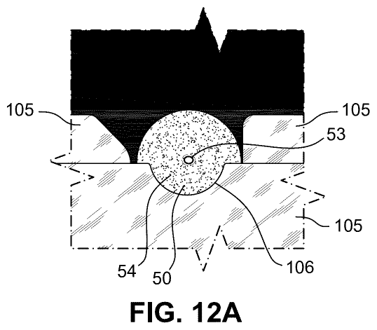

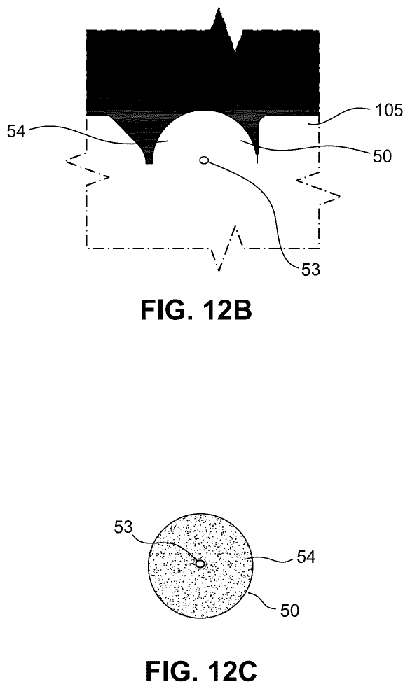

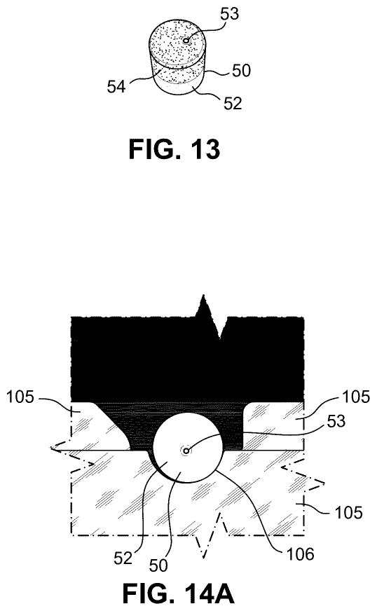

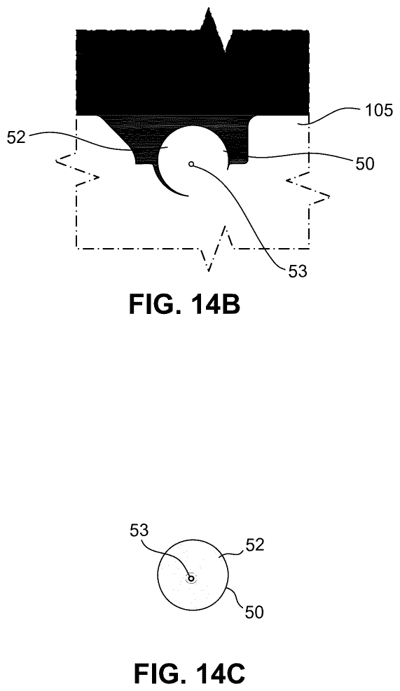

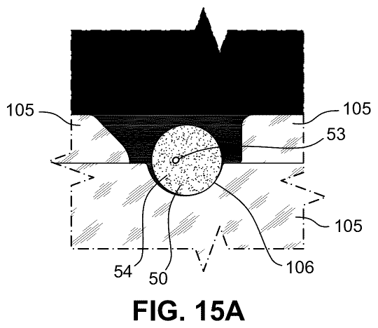

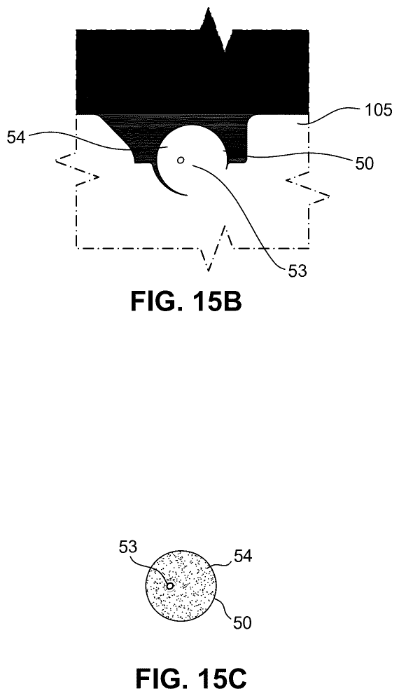

The effect of illuminating pellet-shaped articles 50 with UV light during imaging stages, as described above, is depicted in FIGS. 6-15C. FIG. 6 shows a cross-section of a hole 53 in the first side 52 of a pellet-shaped article 50. The incident UV light 55 impacts a rough surface 51 of the first side 52 that has not been processed, e.g., by drilling with a laser, and the UV light 55 reflected the rough surface 51 of the first side 52 scatters differently than light reflected from the smoother surface of the hole 53. The difference in the way UV light 55 is reflected from the hole 53 versus the rough surface 51 around it may allow for a sharper contrast in post-processing images. That sharper contrast may permit more precise measurement and detailed analysis of the post-processing images by the controller 200 when it compares the hole 53 against the hole specification, for example, to determine whether a given pellet-shaped article 50 is defective.

The sharper contrast provided by the reflected UV light 55 can also highlight differences between the first side 52 and the second side 54 of a pellet-shaped article 50 because the first side 52 and the second side 54 may have different surface textures, in addition to being different colors, by virtue of being different materials (see FIG. 4C). Also, the sharper contrast provided by the reflected UV light 55 can also highlight boundaries of the pellet-shaped articles 50 more clearly to determine whether there may be any surface imperfections, whether they may be misshapen, or whether they are seated properly or improperly in a corresponding one of the pockets 106. This may be beneficial at the pre-processing imaging stage, as well as the post-processing imaging stage, to ensure that the pellet-shaped articles 50 are not defective in any respect before or after processing.

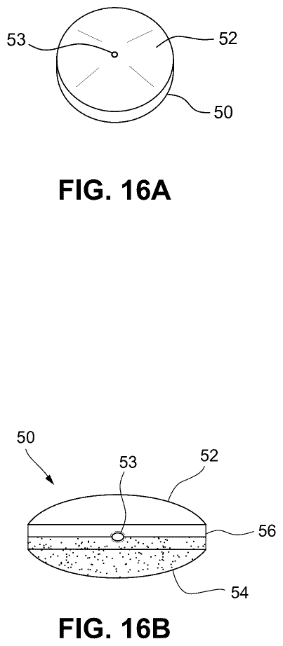

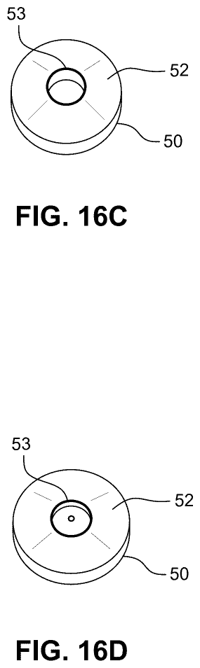

FIGS. 16A-16D show variations of the hole 53 that can be detected by imaging under UV light and subsequent analysis. FIG. 16A show a hole 53 on the first side 52 of the pellet-shaped article 50 that is within specification. It is positioned at approximately the centroid of the first side 52 and extends into the pellet-shaped article 50 along an axis perpendicular to a plane between the first side 52 and the second side 54 of the pellet-shaped article 50. FIG. 16B shows a defective hole 53 located on the belly band 56 of the pellet-shaped article 50. FIG. 16C shows a hole 53 positioned at approximately the centroid of the first side 52 and extending into the pellet-shaped article 50 along an axis perpendicular to a plane between the first side 52 and the second side 54 of the pellet-shaped article 50, but unlike FIG. 16A, the hole 53 is oversized and extends completely through the pellet-shaped article 50. FIG. 16D shows a defective hole 53 similar to FIG. 16C in that it is too large, and even though it is a blind hole, it is still too deep.

The sharper contrast provided by UV light during the imaging stages is advantageous because it allows the controller 200 to more easily determine the parameters of a given hole 53 from corresponding pre- and/or post-processing images, and thus whether it is within specification, as in FIG. 16A, or not, as in FIGS. 16B-16D. Furthermore, the sharper contrast can also permit the controller 200 to detect a pellet-shaped article 50 that is errantly positioned in its pocket 106 before processing to avoid it being processed incorrectly, as in FIG. 16B. While that pellet-shaped article 50 might be ejected before errant processing, it might be able to be recycled if it is not processed at all, whereas if it were processed incorrectly, it might be discarded completely. This can save costs for the manufacturer because fewer pellet-shaped articles 50 are wasted due to errant processing.

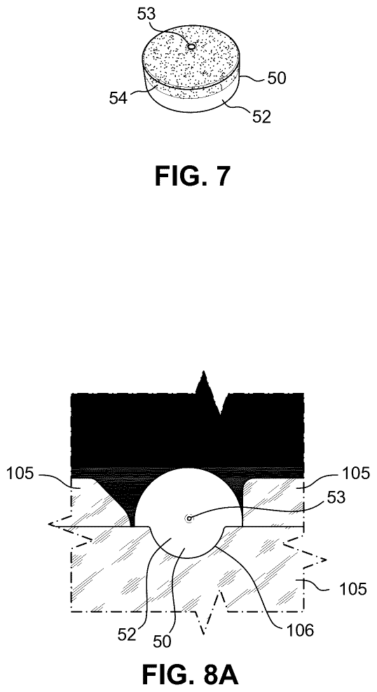

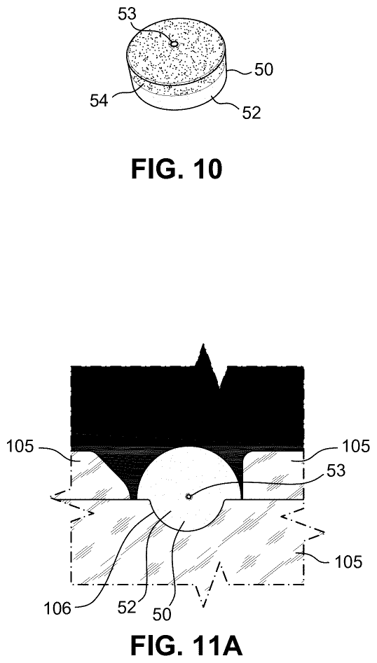

FIG. 7-15C show various pellet-shaped articles 50 and how the controller 200 may manipulate images thereof to assess whether a given pellet-shaped article 50 is within specification. FIGS. 7-9C show a pellet-shaped article 50 with a very light colored or white first side 52 and a darker second side 54. FIGS. 10-12C show a pellet-shaped article 50 with a light colored first side 52 and a darker second side 54. In this example, the color of the first side 52 is visually closer to the color of the second side 54 than is the case of the pellet-shaped article 50 of FIGS. 7-9C. FIGS. 10-12C show a pellet-shaped article 50 with a light colored first side 52 and a darker second side 54, and the pellet-shaped article 50 in this example is a longitudinally compressed tablet (LCT). Again, in this example, the color of the first side 52 is visually closer to the color of the second side 54 than is the case of the pellet-shaped article 50 of FIGS. 7-9C. In the latter two examples where the color of the first side 52 is visually closer to the color of the second side 54, illuminating the pellet-shaped articles 50 provides easier distinguishment between the first side 52 and the second side 54 because the UV light highlights the differences in surface texture with sharper contrast for analysis by the controller.

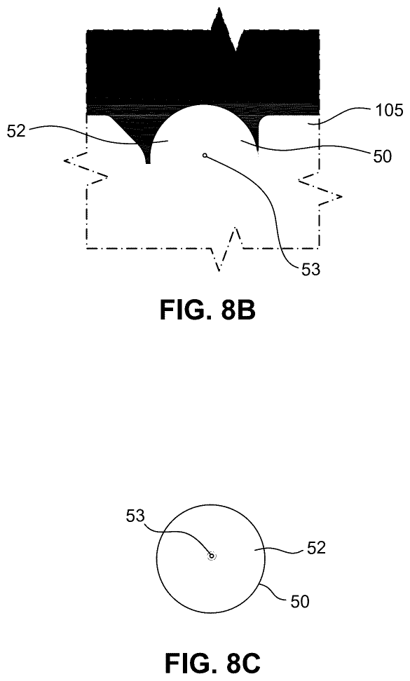

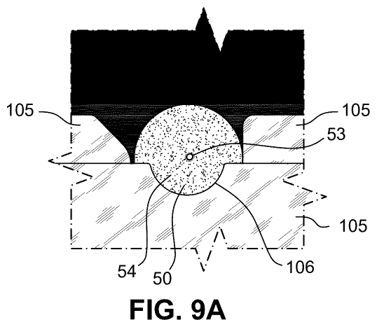

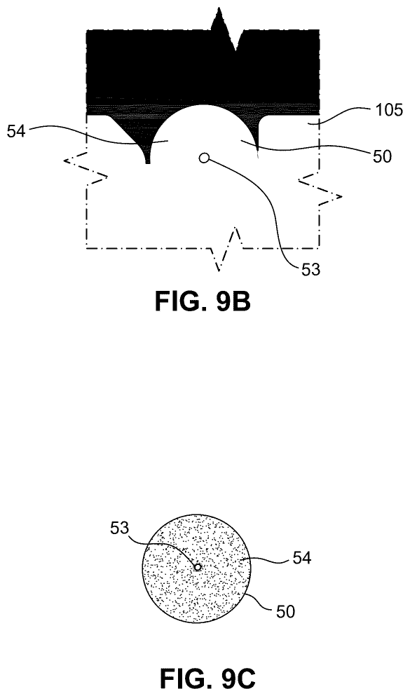

FIG. 7 shows the lighter-colored first side 52 and the darker-colored second side 54 of the pellet-shaped article 50. FIGS. 8A and 9A show the lighter-colored first side 52 and the darker-colored second side 54 of the pellet-shaped article 50, respectively, when the pellet-shaped article 50 is seated in the pocket 106 of the carrier link 105. These images depict the carrier link 105 and the pellet-shaped article 50 illuminated by UV light in a raw form as imaged by respective ones of the first post-processing camera 172 and the second post-processing camera 174, which is evident from the texture of the first side 52 and the second side 54 being visible. To create even further contrast for analysis by the controller 200, the raw images of FIGS. 8A and 9A are binarized to create FIGS. 8B and 9B, respectively. Binarization may be performed by controller 200 by assigning a number to each pixel based on the color or intensity of light (e.g., as measured in candelas) detected by the controller 200. The binarized images are then created by replacing pixels with a number above a certain threshold with a pixel of a first color (e.g., black) and replacing pixels with a number below a certain threshold with a pixel of a second color (e.g., white). The binarized images of FIGS. 8B and 9B and their even sharper contrast can then be analyzed by the controller 200 to determine whether the pellet-shaped article 50 and its hole 53 are within specification. FIGS. 8C and 9C show direct side views of the first side 52 and the second side 54 to more clearly depict the color and texture of each side.

It should also be noted that examples above described that the hole 53 may be drilled only on the first side 52 and not the second side 64 of each pellet-shaped article 50. FIGS. 9A-9C show a pellet-shaped article 50 with hole 53 on the second side 54 to depict how this system can use the contrast provided by UV light and binarization to make an errant hole 53 easily detectible by the controller 200.

FIGS. 10-12C and FIGS. 13-15C show similar images to FIGS. 7-9C. However, as noted above, the respective colors of the first side 52 and the second side 54 are visually closer in these examples. FIGS. 10-12C and FIGS. 13-15C indicate how the contrast provided by UV light and binarization still provide clear visual boundaries for analysis by the controller 200, which might not be possible if traditional white light illumination had been used.

It should also be understood that while the improved contrast offered by UV light illumination and binarization is discussed in the context of post-processing images, those benefits are similarly applicable to pre-processing images.

While the technology has been described in connection with various examples of the technology, it is to be understood that the technology is not to be limited to the disclosed examples, but on the contrary, is intended to cover various modifications and equivalent arrangements included within the spirit and scope of the technology. Also, the various examples described above may be implemented in conjunction with other examples, e.g., aspects of one example may be combined with aspects of another example to realize yet other examples. Further, each independent feature or component of any given assembly may constitute an additional example.

REFERENCE CHARACTER LIST

| | |
|---|---|
| pellet - shaped article | 50 |
| rough surface | 51 |
| first side | 52 |
| hole | 53 |
| second side | 54 |
| UV light | 55 |
| belly band | 56 |
| ejection unit | 90 |
| conveyer apparatus | 100 |
| conveyer | 101 |
| feed hopper | 102 |
| carrier link | 105 |
| pocket | 106 |
| first inspection unit | 150 |
| first pre-processing camera | 152 |
| second pre-processing camera | 154 |
| processing unit | 160 |
| first laser | 162 |
| second laser | 164 |
| second inspection unit | 170 |
| first post-processing camera | 172 |
| second post-processing camera | 174 |
| controller | 200 |
| CPU | 202 |
| RAM | 204 |
| memory device | 206 |

What is claimed is:

1. A conveyer apparatus for inspecting and processing pellet-shaped articles, each of the pellet-shaped articles including a first side with a first characteristic and a second side opposite the first side and having a second characteristic that is different from the first characteristic, the conveyer apparatus comprising:
a conveyer including a plurality of carrier links configured to circulate along a conveyer path to convey a plurality of pellet-shaped articles along a portion of the conveyer path, each carrier link having a pocket configured to receive a pellet-shaped article in an orientation with the first side or the second side of the pellet-shaped article facing a first lateral side of the conveyer path and the other of the first side or the second side of the pellet-shaped article facing a second lateral side of the conveyer path;
a first pre-processing camera located on the first lateral side of the conveyer path, the first pre-processing camera being configured to generate a first pre-processing image of whichever of the first side or the second side of each of the pellet-shaped articles is facing the first lateral side of the conveyer path as the pellet-shaped articles are conveyed past the first pre-processing camera;
a controller configured to receive the first pre-processing image of each of the pellet-shaped articles from the first pre-processing camera and determine whether the first side or the second side of each of the pellet-shaped articles is facing the first lateral side of the conveyer path based on whether the first pre-processing image contains the first characteristic or the second characteristic;
a first processing device located on the first lateral side of the conveyer path and a second processing device located on the second lateral side of the conveyer path, each of the first processing device and the second processing device being configured to process the first side of each of the pellet-shaped articles to produce a third characteristic on the first side of each of the pellet-shaped articles as the pellet-shaped articles are conveyed past the first processing device and the second processing device in response to a first instruction from the controller that is based on a determination by the controller that the first side of each of the pellet-shaped articles faces the first lateral side or the second lateral side of the conveyer path;
a first post-processing camera located on the first lateral side of the conveyer path and a second post-processing camera located on the second lateral side of the conveyer path;
a post-processing light source configured to illuminate the pellet-shaped articles with ultraviolet (UV) light as the pellet-shaped articles are conveyed past the first post-processing camera and the second post-processing camera; and
an ejection unit configured to eject individual ones of the pellet-shaped articles from a corresponding one of the carrier links,
wherein the first post-processing camera is configured to generate a first post-processing image of whichever of the first side or the second side of each of the pellet-shaped articles is facing the first lateral side of the conveyer path and illuminated with UV light and the second post-processing camera is configured to generate a second post-processing image of whichever of the first side or the second side of each of the pellet-shaped articles is facing the second lateral side of the conveyer path and illuminated with UV light,
wherein the controller is configured to receive the first post-processing image and the second post-processing image of each of the pellet-shaped articles from the first post-processing camera and the second post-processing camera, respectively, and detect presence or absence of the third characteristic on the first side of each of the pellet-shaped articles in the first post-processing image or the second post-processing image, and
wherein the ejection unit is configured to eject individual ones of the pellet-shaped articles from a corresponding one of the carrier links in response to a second instruction from the controller that is based on the controller detecting that the third characteristic is absent from the first side of an individual one of the pellet-shaped articles.

2. The conveyer apparatus of claim 1, wherein the first characteristic is a first color and the second characteristic is a second color that is different from the first color.

3. The conveyer apparatus of claim 1, wherein the first color is lighter than the second color.

4. The conveyer apparatus of claim 1, wherein the first processing device is a first laser configured to drill a hole into each of the pellet-shaped articles and the second processing device is a second laser configured to drill a hole into each of the pellet-shaped articles.

5. The conveyer apparatus of claim 4, wherein the first laser and the second laser are configured to drill the hole at a centroid of the first side of each of the pellet-shaped articles and coaxial to an axis perpendicular to a plane between the first side and the second side of each of the pellet-shaped articles.

6. The conveyer apparatus of claim 4, wherein the hole is a blind hole.

7. The conveyer apparatus of claim 4, wherein the third characteristic comprises at least one of the size, the shape, the depth, and the position of the hole drilled into the first side of each of the pellet-shaped articles.

8. The conveyer apparatus of claim 7, wherein the controller is configured to compare at least one of the size, the shape, the depth, and the position of the hole to a hole specification and determine whether the hole drilled into the first side of each of the pellet-shaped articles is within the hole specification.

9. The conveyer apparatus of claim 8, wherein the controller is configured to instruct the ejection unit to eject an individual one of the pellet-shaped articles if the controller determines that at least one of the size, the shape, the depth, and the position of the hole is not within the hole specification.

10. The conveyer apparatus of claim 1, wherein the controller is configured to not instruct the first processing device and the second processing device to process the second side of each of the pellet-shaped articles.

11. The conveyer apparatus of claim 1, wherein the ejection unit is configured to eject individual ones of the pellet-shaped articles from a corresponding one of the carrier links in response to a third instruction from the controller that is based on the controller detecting that the third characteristic is present on the second side of an individual one of the pellet-shaped articles.

12. The conveyer apparatus of claim 1, further comprising a second pre-processing camera located on the second lateral side of the conveyer path, the second pre-processing camera being configured to generate a second pre-processing image of whichever of the first side or the second side of each of the pellet-shaped articles is facing the second lateral side of the conveyer as the pellet-shaped articles are conveyed past the second pre-processing camera.

13. The conveyer apparatus of claim 12, wherein the controller is configured to receive the second pre-processing image of each of the pellet-shaped articles from the second pre-processing camera and determine whether the first side or the second side of each of the pellet-shaped articles is facing the first lateral side of the conveyer path based on whether the second pre-processing image contains the first characteristic or the second characteristic.

14. The conveyer apparatus of claim 12, wherein the controller is configured to receive the second pre-processing image of each of the pellet-shaped articles from the second pre-processing camera, and
wherein the controller is configured to determine from the first pre-processing image and the second pre-processing image whether at least one of the following:
each of the pellet-shaped articles is within a predetermined size specification,
each of the pellet-shaped articles is within a predetermined shape specification, and
each of the pellet-shaped articles is within a predetermined position specification in the pocket of a corresponding one of the carrier links.

15. The conveyer apparatus of claim 14, wherein the controller is configured to not instruct the first processing device and the second processing device to process said pellet-shaped article and to instruct the ejection unit to eject said pellet-shaped article, if the controller determines that an individual one of the pellet-shaped articles is not within at least one of the predetermined size specification, the predetermined shape specification, and the predetermined position specification.

16. The conveyer apparatus of claim 1, wherein the post-processing light source is configured to emit light only in the UV spectrum.

17. The conveyer apparatus of claim 1, further comprising a pre-processing light source configured to illuminate the pellet-shaped articles with ultraviolet (UV) light as the pellet-shaped articles are conveyed past the first pre-processing camera.

18. The conveyer apparatus of claim 17, wherein the pre-processing light source is configured to emit light only in the UV spectrum.

19. The conveyer apparatus of claim 1, further comprising a pre-processing light source configured to illuminate the pellet-shaped articles with white light as the pellet-shaped articles are conveyed past the first pre-processing camera.

20. The conveyer apparatus of claim 19, wherein the pre-processing light source is configured to emit only white light.

21. The conveyer apparatus of claim 1, further comprising a post-processing shield configured to block ambient light from the first post-processing camera and the second post-processing camera.

22. The conveyer apparatus of claim 1, further comprising a pre-processing shield configured to block ambient light from the first pre-processing camera.

23. The conveyer apparatus of claim 1, further comprising a feed hopper configured to feed the pellet-shaped articles into the carrier links.

24. The conveyer apparatus of claim 1, wherein the controller is configured to analyze one or more of each pre-processing image and each post-processing image of each of the pellet-shaped articles by:
assigning a number to each pixel in each pre-processing image and each post-processing image based on the color detected by the controller,
replacing pixels with a number above a threshold with a pixel of a first color, and
replacing pixels with a number below the threshold with a pixel of a second color that is different from the first color.

25. The conveyer apparatus of claim 1, wherein the first characteristic is visually distinguishable from the second characteristic.

26. A system for analyzing images of pellet-shaped articles transported by in carrier links of a conveyer along a conveyer path having a first lateral side and a second lateral side, each of the pellet-shaped articles including a first side with a first characteristic and a second side opposite the first side and having a second characteristic that is different from the first characteristic, the system comprising:
a processor configured to:
receive a first pre-processing image of each of the pellet-shaped articles from a first pre-processing camera and determine whether the first side or the second side of each of the pellet-shaped articles is facing the first lateral side of the conveyer path based on whether the first pre-processing image contains the first characteristic or the second characteristic;
instruct a first processing device located on the first lateral side of the conveyer path or a second processing device located on the second lateral side of the conveyer path to process the first side of each of the pellet-shaped articles to produce a third characteristic on the first side of each of the pellet-shaped articles as the pellet-shaped articles are conveyed past the first processing device and the second processing device based on a determination that the first side of each of the pellet-shaped articles faces the first lateral side or the second lateral side of the conveyer path;
receive a first post-processing image and a second post-processing image of each of the pellet-shaped articles from a first post-processing camera and a second post-processing camera, respectively, and detect presence or absence of the third characteristic on the first side of each of the pellet-shaped articles in the first post-processing image or the second post-processing image; and
instruct an ejection unit to eject individual ones of the pellet-shaped articles from a corresponding one of the carrier links if the processing system detects that the third characteristic is absent from the first side of an individual one of the pellet-shaped articles.

27. The system of claim 26, wherein the first post-processing image and the second post-processing image depicts each of the pellet-shaped articles illuminated with ultraviolet (UV) light from a post-processing light source.

28. The system of claim 26, wherein the processing system is configured to analyze one or more of each pre-processing image and each post-processing image of each of the pellet-shaped articles by:
assigning a number to each pixel in each pre-processing image and each post-processing image based on the color or light intensity detected by the controller,
replacing pixels with a number above a threshold with a pixel of a first color, and
replacing pixels with a number below the threshold with a pixel of a second color that is different from the first color.
